(19) United States
(12) Patent Application Publication
(10) Pub. No.: US 2006/0232066 A1
(43) Pub. Date: Oct. 19, 2006

(54) Connection device

(76) Inventors: Hidekazu Kanagae, Kumamoto (JP); Kazunori Yoshii, Kumamoto (JP); Kuniyoshi Matsuzawa, Kumamoto (JP)

Correspondence Address: JACOBSON HOLMAN PLLC, 400 SEVENTH STREET N.W., SUITE 600, WASHINGTON, DC, 20004, US

(21) Appl. No.: 10/540,870

(22) PCT Filed: Dec. 26, 2003
(86) PCT No.: PCT/JP03/17038

§ 371 Date: Mar. 9, 2006

(30) Foreign Application Priority Data
Dec. 27, 2002 (JP) 2002-382243
Feb. 6, 2003 (JP) 2003-029196

(51) Int. Cl. F16L 17/00

(52) U.S. Cl. 285/348; 285/347

(57) ABSTRACT

A pipe connector device able to simply and effectively seal connected members even when using a seal member through which a gas easily permeates is provided. A connector device 1 provides flow paths 7a and 9a for carrying a pressurized gas, is formed by first and second connection members 7 and 9 connected to each other, an O-ring 11 for sealing sealing surfaces S1 and S2 of the connection members 7 and 9, and a material more resistant to permeation of gas through it than the O-ring 11, and has a backup ring 13 having a support surface 13S for supporting the O-ring 11 receiving a pressure difference between the insides and outsides of the connection members 7 and 9 and a tapered surface 19T on which a distance between the sealing surfaces S1 and S2 at a fit position of the backup ring 13 gradually decreases toward a non gas pressurization side.

### TECHNICAL FIELD

The present invention relates to a seal device or a connector device for preventing or reducing leakage of a pressurized gas from a connected portion of a connecting hollow member connecting pipes through which the pressurized gas is passed.

Particularly, the present invention relates to a seal device or a connector device improved in sealing effect by reducing the permeation of gas from a seal member.

### BACKGROUND ART

In an air conditioner or other cooling device used for cooling an automobile or other vehicle or a room, a refrigerant flows in the pipes.

In the past, chlorofluorocarbon gas was used as the refrigerant, but due to the environmental problem of chlorofluorocarbon gas destroying the ozone layer, cooling devices using carbon dioxide gas (CO₂) in place of chlorofluorocarbon gas as the refrigerant are also being used.

When using carbon dioxide gas as the refrigerant, carbon dioxide gas pressurized to a pressure higher than that of the case when using chlorofluorocarbon gas, for example, a pressure of about 15 MPa, flows inside the pipes. When connecting pipes through which the pressurized carbon dioxide gas flows, usually it may be used, for example an O-ring or other seal member made of rubber and a backup ring. The seal member is arranged so as to seal the sealing surface of one connecting hollow member provided in a connection part of the pipes and the sealing surface of the other connecting hollow member. The backup ring is used for securing the seal performance of the seal member by preventing the O-ring or other seal part from being deformed due to a pressing action of the pressurized gas and protruding into the space between the pipes due to the pressure difference between the pressure of the gas inside the pipes and the outside of the pipes. Namely, the backup ring is arranged so as to support the seal member in a movement direction in which the seal member moves due to the pressure difference between the inside of the pipes through which the pressurized carbon dioxide gas flows and the outside of the pipes. The backup ring had a rectangular (block) sectional shape in the past.

When the pressure of the gas is about 15 MPa, it was possible to sufficiently prevent the protrusion of the seal member by the backup ring having a rectangular cross-section.

Further, as disclosed in Japanese Unexamined Publication No. 2001-208201, a technique of sealing pipes through which high pressure carbon dioxide gas flows by using a packing member made of a polyamide resin and having a U-shaped or Y-shaped cross-section is known.

When using chlorofluorocarbon gas, by using a general purpose O-ring made of rubber, it was possible to prevent the leakage of the chlorofluorocarbon gas from the connection member.

However, carbon dioxide gas, which has a lower molecular weight than chlorofluorocarbon gas, by its nature permeates through the rubber used as the seal member. When raising the pressure of the carbon dioxide gas as explained above, the carbon dioxide gas further easily permeates through the rubber.

A conventional backup ring has been produced mainly for supporting the O-ring. With just supporting an O-ring made of rubber by a backup ring, the carbon dioxide gas permeating through the O-ring leaks from the clearance between the backup ring and the connecting member and leaks to the outside of the pipes, so it is not possible to obtain a sufficient seal performance. As a result, for example the amount of the carbon dioxide gas used as the refrigerant in the cooling device gradually decreases and the possibility arises of the cooling performance dropping.

Further, when using a special packing member having a special material and sectional shape in a cooling device, it suffers from the disadvantages of a rise of cost for preparing the special packing member and the loss in the general compatibility as a cooling device mounted in a vehicle or a cooling device used in a room.

### DISCLOSURE OF THE INVENTION

An object of the present invention is to provide a connector device (or seal device) able to simply and effectively seal members to be connected even when using a general purpose seal member through which the pressurized gas easily permeates.

According to the present invention, there is provided a connector device having: a gas sealing means deforming in accordance with a pressing action; and first and second connecting hollow members, each formed by a material not allowing permeation of pressurized gas through it, forming a connection part having a hollow part through which a pressurized gas is passed, and having a groove in which the gas sealing means is arranged in a part where the gas of the connection part leaks. The groove in which the gas sealing means is arranged is formed in a path through which the pressurized gas is leaked and discharged at a connection part of the first and second connecting hollow members. The groove has a first part into which the gas is introduced and on which a high pressure is applied and a second part connected to the first part and in which a low pressure of the gas being discharged is applied, a sectional area of the second part is smaller than the sectional area of the first part. The gas sealing means arranged in the groove is deformed due to a pressure difference between the high pressure and the low pressure and prevents the leakage of the gas from the clearance in the second part of the groove.

Preferably, the gas sealing means is deformed by the pressing action of the pressurized gas introduced into the first part of the groove, enlarges in a diametrical direction in the second part, and narrows the clearance of the second part to such an extent where the gas is not leaked from the clearance.

More preferably, the pressurized gas is heated, and the gas sealing means is formed by a material which is heated by the temperature of the heated pressurized gas and further enlarged in the diametrical direction in the second part.

Preferably, the gas sealing means has a first gas seal member made of rubber arranged in the first part of the groove and deformed in the groove by the pressing action of the pressurized gas and a second gas seal member which is formed by a material not allowing permeation of the pressurized gas through it and having a smaller deformation than the first gas seal member, arranged in the second part of the groove adjacent to the first gas seal member so as to suppress the movement of the first gas seal member by the pressing action of the pressurized gas, enlarged in the diametrical direction in the second part of the groove by the deformation of the first gas seal member and the pressing action by the movement to narrow the clearance of the second part to an extent where the gas is not leaked from the clearance.

Specifically, the first gas seal member is an O-ring made of rubber, and the second gas seal member is formed by a plastic or synthetic polymer material, not allowing the permeation of the pressurized gas through it.

Preferably, the second part of the groove is inclined so as to become shallower than the depth of the first part toward a direction in which the gas is discharged, and the part of the second gas seal member contacting the inclined surface of the second part of the groove is inclined and can move on the inclined surface of the second part of the groove at the time of the pressing action by the pressurized gas.

More preferably, the angle of the inclined surface of the second gas seal member contacting the second part of the groove is larger than the angle of the inclined surface of the second part of the groove, and a front end of the inclined surface of the first gas seal member is crushed at the time of the pressing action by the pressurized gas to further narrow the clearance of the second part.

Specifically, the pressurized gas is pressurized carbon dioxide gas.

Preferably, the first and second connecting hollow members have hollow parts for fitting connecting a first pipe and a second pipe.

As described above, according to the present invention, even when using a general purpose gas sealing means through which a gas can easily permeate, the groove having the second part smaller in its sectional area than the first part enables leakage of the gas to be effectively lowered.

When using the first gas seal member and the second gas seal member as the gas sealing means, further effective gas leakage becomes possible.

### BRIEF DESCRIPTION OF THE DRAWINGS

FIG. 1 is a sectional view of a connector device according to a first embodiment of the present invention.

FIG. 2 is a partially enlarged view of the connector device illustrated in FIG. 1.

FIGS. 3A to 3C are sectional views and a front view of the backup ring illustrated in FIG. 1 and FIG. 2.

FIG. 4 is a partially enlarged view of the connector device of a modification of the first embodiment of the present invention.

FIGS. 5A and 5B are partially enlarged views of a connector device of another modification of the first embodiment of the present invention.

FIGS. 6A to 6C are views for explaining the effects of the backup ring applied to the connector device of the present invention.

FIGS. 7A and 7B are views for explaining the shape of a first type of the backup ring in the connector device of the first embodiment of the present invention and the effects thereof.

FIGS. 8A and 8B are views for explaining the shape of a second type of the backup ring in the connector device of the first embodiment of the present invention and the effects thereof.

FIGS. 9A and 9B are sectional views of the connector device according to a second embodiment of the present invention and its partially enlarged view.

FIG. 10 and FIG. 11 are sectional views of the connector device according to a third embodiment of the present invention and its partially enlarged view.

FIG. 12 is a sectional view of the connector device according to a fourth embodiment of the present invention and its partially enlarged view.

FIG. 13 is a sectional view of a connector device combining the connector device of the first embodiment and the connector device of the third embodiment as a connector device according to a fifth embodiment of the present invention.

FIG. 14 is a sectional view of a connector device combining the connector device of the first embodiment and the connector device of the fourth embodiment as a connector device according to a sixth embodiment of the present invention.

FIG. 15 is a sectional view of a connector device combining the connector device of the first embodiment and the connector device of the second embodiment as a connector device according to a seventh embodiment of the present invention.

### BEST MODE FOR CARRYING OUT THE INVENTION

Preferred embodiments of the present invention will be described with reference to the accompanying drawings.

As an example of an embodiments of the present invention, as the pressurized gas of the present invention, for example pressurized carbon dioxide gas (hereinafter referred to as “pressurized carbon dioxide gas”) used as the refrigerant of a cooling device is illustrated. The leakage of the pressurized carbon dioxide gas from a connected portion of two connecting hollow members for connecting two pipes is illustrated as an illustration of the part where the pressurized gas is leaked. Further, the pressurized carbon dioxide gas used as the refrigerant of the cooling device is sometimes heated to about for example 40 to 80° C. This will be referred to as the “pressurized and heated carbon dioxide gas. Naturally, the present invention is not limited to such an illustration.

### First Embodiment

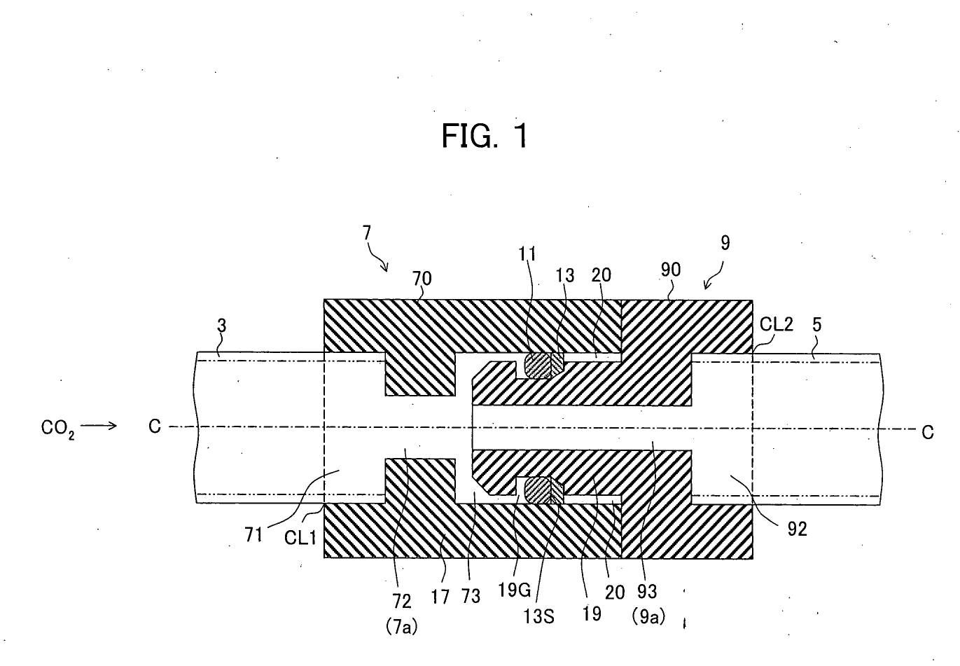

A first embodiment of the present invention will be described with reference to FIG. 1 to FIG. 4.

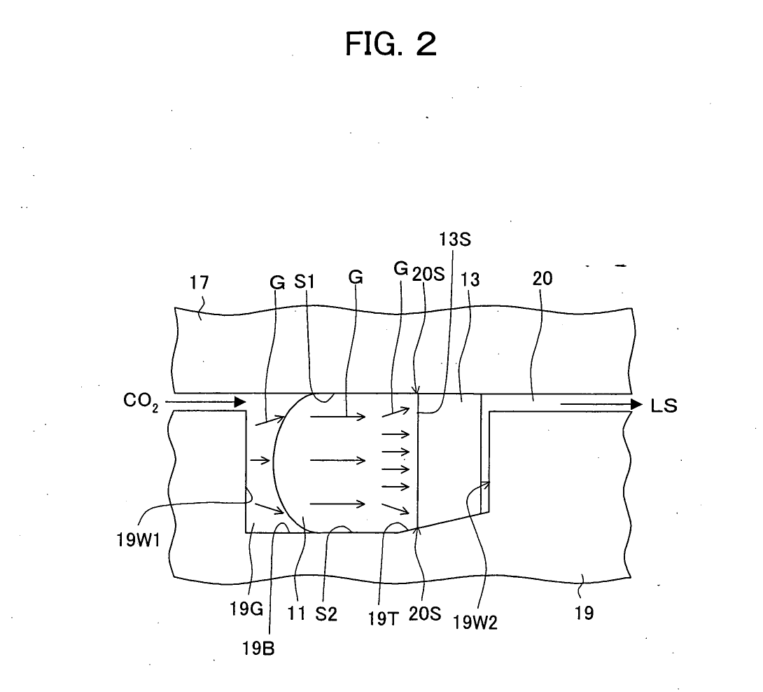

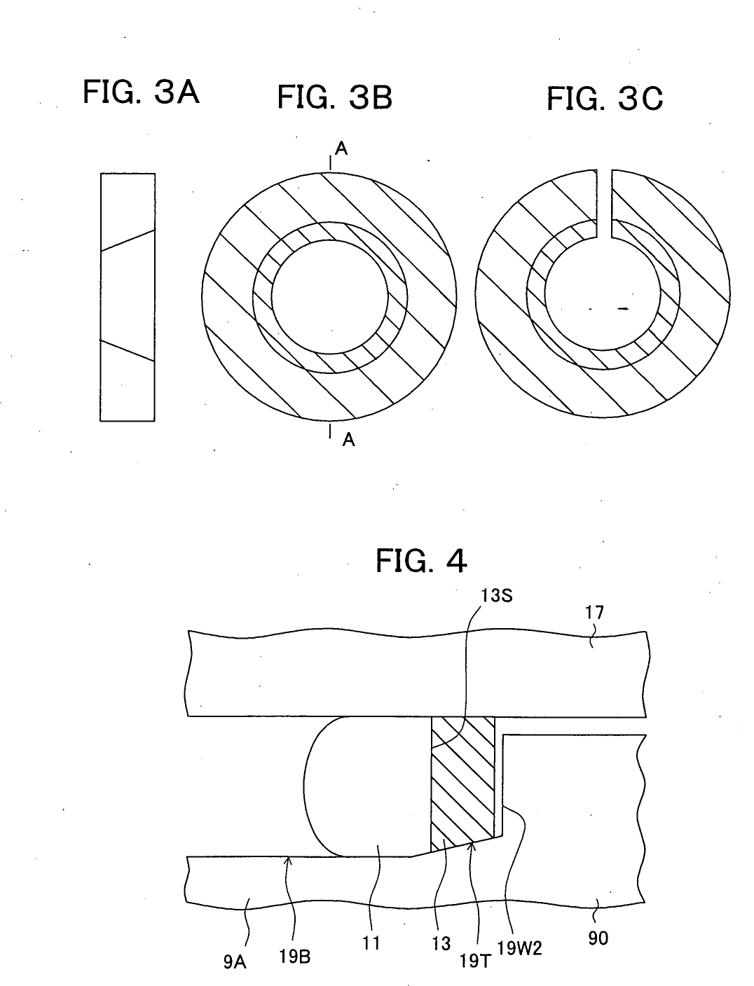

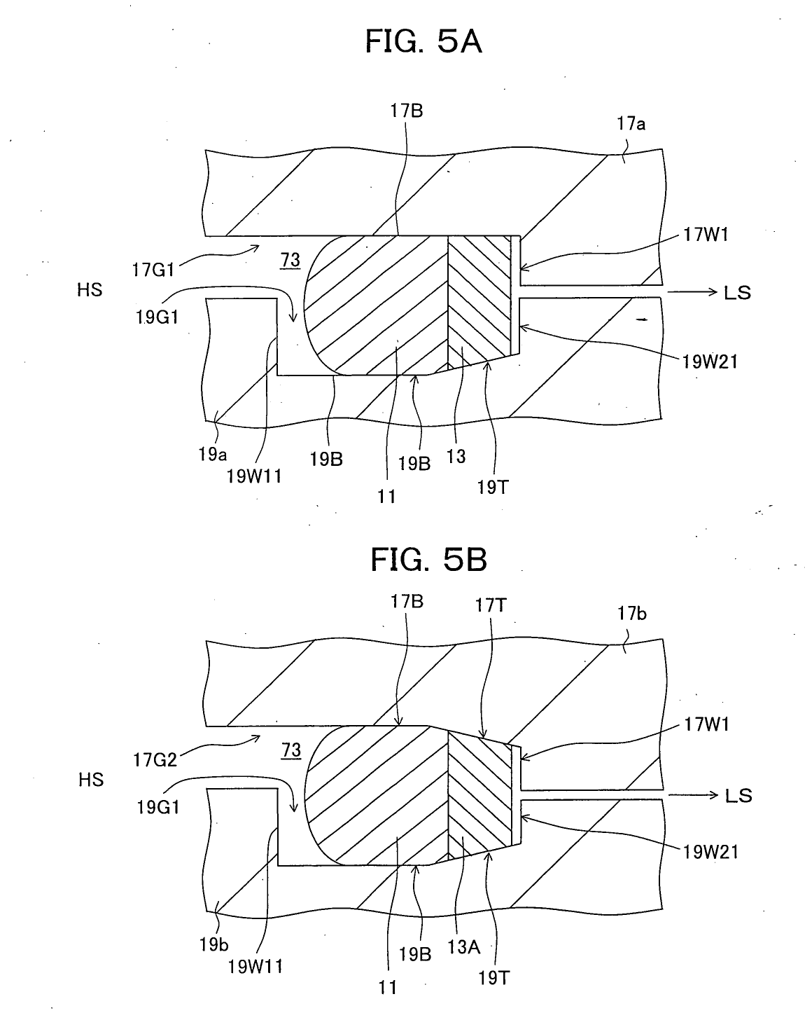

FIG. 1 is a sectional view showing a gas pipe connector device as a seal device according to the first embodiment of the present invention, FIG. 2 is a partially enlarged view of a connection part illustrated in FIG. 1, FIG. 3A is a sectional view of a backup ring, FIG. 3B is a front view of a first type of the backup ring, and FIG. 3C is a front view of a second type of the backup ring. FIG. 4 is a view illustrating another type of the second connection member.

A connector device 1 has a first pipe 3, a second pipe 5, a first pipe connection member 7, a second pipe connection member 9, a seal member 11 used as the first gas seal member of the embodiment of the present invention, and a backup ring 13 used as the second gas seal member of the embodiment of the present invention. The first gas seal member and the second gas seal member form the gas sealing means of the embodiment of the present invention.

The hollow first pipe connection member (hereinafter abbreviated as “the first connection member”) 7 through which the pressurized and heated carbon dioxide gas (carbon dioxide gas) passes along a direction of an axial center C-C of the first pipe 3 and the second pipe 5 is an embodiment of the first connecting hollow member in the present invention, and the hollow second pipe connection member (hereinafter abbreviated as “the second connection member”) 9 is also an embodiment of the second connecting hollow member in the present invention.

The first connection member 7 is constituted by a main body 70 and a housing 17 connected to the main body 70. In the main body 70, a first hollow part 71 and a second hollow part 72 communicated with the first hollow part 71 are formed, while in the housing 17, a third hollow part 73 communicated with the second hollow part 72 is formed. In the present embodiment, the cross-section of the main body 70 and the housing part 17 is circular. The first to third hollow parts 71 to 73 forming a path of the pressurized carbon dioxide gas are coaxially formed and communicated.

The second connection member 9 has a shaft 19 having a circular cross-section inserted inside the third hollow part 73 of the first connection member 7, a main body 90 having a surface which is connected to a shaft 19 and abuts against the front end of the third hollow part 73 of the first connection member 7, a fourth hollow part 92 formed on the other end of the main body 90, and a fifth hollow part 93 continuing from (communicated with) the fourth hollow part 92 from the front end of the shaft 19. The fourth and fifth hollow parts 92 and 93 forming the path of the pressurized carbon dioxide gas are coaxially formed and communicated.

An inside diameter of the first hollow part 71 is formed to an outside diameter in which the pipe 3 can fit. The inside diameter of the fourth hollow part 92 is formed to an outside diameter in which the pipe 5 can fit.

The inside diameter of the third hollow part 73 is a size securing a predetermined clearance enabling insertion of the shaft 19 into the third hollow part 73 while for example the O-ring 11 contacts the third hollow part 73 in the state where the O-ring 11 and the backup ring 13 are mounted (arranged) in the groove 19G formed in the shaft 19. In this way, in a state where the O-ring 11 and/or backup ring 13 is not arranged in the shaft 19, a predetermined clearance 20 is defined between the shaft 19 and the third hollow part 73.

The inside diameter of the second hollow part 72 is formed to a size enabling the pressurized carbon dioxide gas to pass while maintaining a strength of the main body 70. In the same way, the inside diameter of the fifth hollow part 93 is formed to a size enabling the pressurized carbon dioxide gas to pass while maintaining a strength of the shaft 19. The inside diameter of the second hollow part 72 and the inside diameter of the fifth hollow part 93 are the same or the inside diameter of the third hollow part 73 is slightly larger than the inside diameter of the fifth hollow part 93.

The first connection member 7 is connected to the first pipe 3, the second connection member 9 is connected to the second pipe 5, and further the first connection member 7 and the second connection member 9 are connected to communicate the first pipe 3 and the second pipe 5.

As the connecting method of the pipe 3 and the connection member 7, for example the pipe 3 is fit into the first hollow part 71 until a wall surface of the second hollow part 72 of the connection member 7 and an end of the pipe 3 abut against each other, and an outer surface CL1 of the abutting part is welded to connect these and prevent leakage of the gas from the connection part. The connecting method of the pipe 5 and the connection member 9 is also the same as that described above. Namely, the pipe 5 is fit in the fourth hollow part 92 until the wall surface of the fifth hollow part 93 of the second connection member 9 and the end of the pipe 5 abut against each other, and an outer surface CL2 of the abutting part is welded to connect them and prevent leakage of the gas from the connection part.

Inside the connection member 7, a flow path 7a through which the pressurized carbon dioxide gas passes is defined in the second hollow part 72 communicated with the pipe 3. In the same way, a flow path 9a through which the pressurized carbon dioxide gas passes is defined in the fifth hollow part 93 communicated with the pipe 5 inside the connection member 9.

When connecting the first connection member 7 connected to the pipe 3 and the second connection member 9 connected to the pipe 5, the shaft 19 is inserted into the third hollow part 93, then the connection member 7 and the connection member 9 are strongly connected with each other by fastening them by for example not illustrated bolts.

Note that, conversely to the method described above, it is also possible to fasten the connection member 7 and the connection member 9 in advance by for example bolts, then connect the pipe 3 and the connection member 7 and connect the pipe 5 and the connection member 9 by the above method.

The carbon dioxide gas flows through the flow paths 7a and 9a and the pipes 3 and 5, defined and communicated when the connection member 7 and the connection member 9 are connected. In the present embodiment, it is assumed that the carbon dioxide gas flows from the pipe 3 side toward the pipe 5 side.

Assume that the carbon dioxide gas used as the refrigerant of the cooling device flows while being pressurized to for example about 15 MPa. Further, when using carbon dioxide gas as the refrigerant of the cooling device, the carbon dioxide gas is sometimes heated to for example about 40 to 80° C.

The pipes 3 and 5 and the connection members 7 and 9 are formed by a material through which the carbon dioxide gas does not permeate to the outside, for example, a metal such as copper and stainless steel, even in a case where carbon dioxide gas pressurized to 15 MPa flows.

In the present embodiment, assume that the pressurized carbon dioxide gas is not leaked from the connection portion of the pipe 3 and the connection member 7 and the connection portion of the pipe 5 and the connection member 9 and consider a case where the pressurized carbon dioxide gas may be leaked from the connection portion of the connection member 7 and the connection member 9.

As shown enlarged in FIG. 2, the shaft 19 has a groove 19G. The groove 19G is defined by a flat bottom 19B, an inclined surface (tapered surface) 19T, and walls 19W1 and 19W2 on the two side of the flat bottom 19B and the tapered surface 19T. The groove 19G having such a cross-section is formed annularly in a circumferential direction perpendicular to the axial direction of the shaft 19. The groove 19G having the tapered surface 19T corresponds to an embodiment of a clearance narrowing means in the present invention.

The tapered surface 19T continues from the flat bottom 19B, and inclined with a predetermined angle so that the depth of the groove 19G becomes shallower to the right side wall 19W2 from the end portion of this bottom 19B toward the direction in which the carbon dioxide gas flows. The direction in which the carbon dioxide gas is leaked is a direction where, as indicated by the arrow, the pressurized carbon dioxide gas permeates through the connected connection members 7 and 9 and leaks to the outside thereof and by which the pressure becomes lower than that inside the connection members 7 and 9. Accordingly, the tapered surface 19T is shaped so that the groove becomes shallower from the flat bottom 19B toward the wall 19W2 on the right side the further toward a low pressure LS side where the pressure becomes lower than the pressure in the groove 19G. In other words, the sectional area of the flat bottom 19B (first sectional area) is larger than the sectional area of the tapered surface 19T (second sectional area).

The flat bottom 19B corresponds to the first part of the groove of the present invention, and the tapered surface 19T corresponds to the second part.

The groove 19G is fit with the seal member 11 as an example of the first gas seal member of the present invention and the backup ring 13 as an example of the second gas seal member of the present invention.

As the seal member 11 of the present embodiment, in the following illustration, an O-ring made of a rubber material which is easily deformed by application of pressure, has resiliency, and is elastic will be described as an example. The O-ring 11 is fit contacting the bottom 19B of the groove 19G of the shaft 19.

As the rubber material used for the O-ring 11, there can be mentioned for example a fluororubber, perfluororubber, hydrated nitrile rubber, nitrile rubber, butyl rubber, ethylene propylene rubber, ethylene propylene diene rubber, polyethylene chloride rubber, chlorosulfonated polyethylene rubber, and epichlorohydrin rubber.

The backup ring 13, as illustrated in FIGS. 3A to 3C, is formed in a ring shape and is attached at a position of the tapered surface 19T at the lower pressure side than the position of the bottom 19B at which the O-ring 11 is attached.

FIG. 3A is a sectional view of the backup ring 13 taken along a line A-A in FIG. 3A, and FIG. 3B and FIG. 3C are front views of the first and second types of the backup ring 13 when viewed from the first wall 19W2 toward the second wall 19W1.

As illustrated in FIG. 3A, the inclined surface of the backup ring 13 faces the tapered surface 19T. Its circumferential edge is a part contacting the third hollow part 73 of the housing 17. Note that the inclined surface of the backup ring 13 is formed so as to have the same inclination as that of the tapered surface 19T or have an inclination different from that of the tapered surface 19T as will be described later. In FIGS. 3B and 3C, the inclined surface is indicated by the narrow hatching.

The backup ring 13 desirably has a complete ring-like shape circling the groove 19G once from the viewpoint of preventing leakage of the pressurized carbon dioxide gas

However, the backup ring 13 is not produced by a material which is elastic like the O-ring 11 and is not easily fit on the groove 19G like the elastic O-ring 11, therefore, as illustrated in FIG. 3C, it is also possible to use a slit (cutting-away) type backup ring 13 obtained by cutting part of the ring and to expand the slit part slightly to arrange the ring in the groove 19G.

When using a non-slit ring-shaped backup ring as the backup ring 13 as illustrated in FIG. 3B, fitting in the groove 19G illustrated in FIG. 2 becomes difficult. Then, as illustrated in FIG. 4, it is desirably to use a second connection member 9A enabling insertion of the backup ring 13 up to the tapered surface 19T from the front end of the shaft 19 and in which a part corresponding to the flat bottom 19B has a continuous endless groove structure. In comparison with the backup ring 13 of FIG. 3B, the pressurized carbon dioxide gas may leak from the slit part. However, the main purpose of the backup ring 13 is basically to form a narrow clearance at a position behind the O-ring 11. Since the O-ring 11 is located at the front of the backup ring 13, there is little leakage from the slit part. In the present invention, the structure illustrated in FIG. 4 is also referred to as the groove 19G.

Since the O-ring 11 is expandable and shrinkable, when fit on a small diameter second connection member 9A and pressed by the pressurized carbon dioxide gas, the O-ring 11 exhibits exactly the same state as illustrated in FIG. 2.

In this way, the groove 19G may have the shape illustrated in FIG. 2 or the shape not having a wall 19W1 as illustrated in FIG. 4. The groove 19G may be a small diameter part on which the O-ring 11 may be fit, for example, the bottom 19B, and a tapered surface on which the backup ring 13 is fit, for example, the tapered surface 19T, and the wall 19W2 against which the pressed backup ring 13 abuts to stop moving.

On the high pressure side where the pressurized carbon dioxide gas is applied in the backup ring 13 contacting the O-ring 11, a support surface 13S supporting the O-ring 11 deformed by the pressing action and moving to the backup ring 13 side is provided.

The O-ring 11 used as the first gas seal member desirably does not allow permeation of nonpressurized air, that is, atmospheric pressure air, of other ordinary state gas and does not allow much permeation of pressurized carbon dioxide gas. However, first, the O-ring 11 is required to be expandable and shrinkable, when fit on the flat bottom 19B and, second, is desired to be low in terms of price. A general purpose rubber O-ring 11 can pass pressurized carbon dioxide gas through it. Further, in the present embodiment, the O-ring 11 is designed estimating that some pressurized carbon dioxide gas may permeate through the O-ring 11. The reason will be described later.

On the other hand, the backup ring 13 used as the second gas seal member is formed by a material not allowing permeation of pressurized carbon dioxide gas through it. Further, desirably the backup ring 13 is not expandable and shrinkable and not easily deformed like the O-ring 11, but has resiliency so that it is slightly deformed by the application of pressure and returns to its original form upon the release of the pressure.

Such a backup ring 13 is formed for example by a polyacrylonitrile resin, polyvinyl alcohol resin, polyamide resin, polyvinylfluoride resin, high density polyethylene resin, polystyrene resin, PEEK resin, PPS resin, LCP resin, polyimide resin, or other resin material. These resin materials have the property that almost no carbon dioxide gas permeates through them. Further, the backup ring 13 may be formed by 46Nylon or other synthetic polymer material resistant to passage of a gas.

Before connecting the pipe 3 and the pipe 5, for example the backup ring 13 illustrated in FIG. 3C is it on the tapered surface 19T part in the groove 19G from the front end of the shaft 19, the O-ring 11 is mounted (fit) on the flat bottom 19B part, then the shaft 19 is inserted into the hollow part 73 of the housing 17 to make the front end surface of the housing 17 and the end surface of the main body 90 abut against each other, and the connection member 7 and the connection member 9 are connected by using for example not illustrated bolts.

The O-ring 11 fit on the bottom 19B of the groove 19G projects from the outside diameter of the shaft 19. When the shaft 19 is inserted into the third hollow part 73 of the housing 17, usually the O-ring 11 contacts the inner wall of the hollow part 73 of the housing 17, is pressed, shrinks due to the compressive force, and forms a sealed state (seals) between the inner wall of the hollow part 73 of the housing 17 and the groove 19G of the shaft 19 with respect to the outside air. Here, the “sealed state with respect to the outside air” means a state sealed to an extent where the outside air of the atmospheric pressure does not enter the third hollow part 73.

The backup ring 13 fit over part of the bottom 19B of the groove 19G and the tapered surface 19T or on the tapered surface 19T just barely does not project or projects from the outside diameter of the shaft 19 in response to the fit position on the tapered surface 19T having the inclined surface. Even when it projects from the outside diameter of the shaft 19, the amount of projection of the backup ring 13 differs according to which position on the tapered surface 19T the backup ring 13 is fit at. When the backup ring 13 is mounted on the tapered surface 19T close to the wall 19W2 side, the amount of projection from the shaft 19 becomes large. Usually, as illustrated in FIG. 2, when the backup ring 13 is inserted into the third hollow part 73 of the housing 17 and the shaft 19 in a state where the O-ring 11 is fit in the groove 19G and on the bottom 19B slightly apart from the wall 19W2, the backup ring 13 may contact the inner wall of the third hollow part 73, shift over the tapered surface 19T to the left side due to its pressure, and move to the bottom 19B side. In this case, the backup ring 13 will sometimes contact the inner wall of the third hollow part 73 and sometimes not contact it.

On the other hand, the O-ring 11 contacts the inner wall of the hollow part 73 to form the “sealed state with respect to the outside air” between the groove 19G of the shaft 19 and the third hollow part 73. In this way, when the shaft 19 is inserted into the hollow part 73 of the housing 17 and the connection member 7 and the connection member 9 are connected, the O-ring 11 contacts the first sealing surface S1 of the inner circumferential surface of the hollow part 73 of the housing 17 and the second sealing surface S2 of the bottom 19B of the groove 19G of the shaft 19 and forms the sealed state (seals) with respect to the outside air between the first sealing surface S1 and the second sealing surface S2.

However, the sealed state by this O-ring 11 is not sufficient against leakage of pressurized carbon dioxide gas. The backup ring 13 becomes necessary for sufficient action against leakage of pressurized carbon dioxide gas.

When pressurized carbon dioxide gas flows from the connection member 7 side toward the connection member 9 side after connecting the connection member 7 and the connection member 9, the O-ring 11 receives the pressure difference between the insides of the connection member 7 and the connection member 9, that is, the third hollow part 73 (path 7a), and the outsides of the connection member 7 and the connection member 9.

The O-ring 11 receiving this pressure difference is pressed to the low pressure LS side shown in FIG. 2. The low pressure LS side corresponds to the nonpressurized side of the carbon dioxide gas pressurized and fed into the connector device 1.

The O-ring 11 pressurized by the pressurized carbon dioxide gas is supported by the support surface 13S of the backup ring 13. For this reason, the O-ring 11 deformed by being pressed by receiving the pressure difference causes the backup ring 13 to be further pressed toward the low pressure LS side, that is the inner wall 19W2, move up on the tapered surface 19T, and abut against the inner wall 19W2. In this state, the backup ring 13 made of a plastic or polymer material and having resiliency is enlarged in diameter in the diametrical direction perpendicular to the pressing direction by the compressive force in the axial direction and resiliently deforms until it close contacts the inclined surface (tapered surface) of the inner circumference contacting the tapered surface 19T, that is, the second sealing surface S2, and the outer circumferential surface contacting the inner wall of the hollow part 73, that is, the first sealing surface S1. Especially, the front end of the inclined surface of the backup ring 13 is thin, so easily resiliently deforms.

Further, the pressurized carbon dioxide gas used as the refrigerant is heated to for example 40 to 80° C. For this reason, not only the O-ring 11, but also the backup ring 13 are heated and easily deform. Especially, the front end of the inclined surface of the backup ring 13 is thin, so easily resiliently deforms.

In this way, the deformation advances and the closeness of contact of the backup ring 13, the first sealing surface S1 and the second sealing surface S2 is further raised. As a result, the sealing effect by the backup ring 13 is further promoted.

As a result, the clearance 20S existing between the sealing surfaces S1 and S2 and the support surface 13S of the backup ring 13 becomes very narrow or the clearance becomes substantially zero, and the amount of the carbon dioxide gas passing through the clearance 20S part sharply decreases or the gas becomes unable to be passed.

Consider the role of the tapered surface 19T. If the groove 19G is formed by the flat bottom 19B and the walls 19W1 and 19W2 or only the wall 19W2 and there is no tapered surface 19T in the groove 19G, it is possible to prevent protrusion of the deformed portion of the O-ring 11 into the clearance 20S between the third hollow part 73 of the housing 17 and the shaft 19 by the backup ring 13, but it is not possible to make the clearance 20S smaller by utilizing the pressure difference explained above.

By the O-ring 11 pressed by the pressurized carbon dioxide gas and the backup ring 13 enlarged in the diametrical direction by the pressing action of the O-ring 11 and further by the heating, the clearance 20S becomes smaller is or is substantially eliminated, that is, the sealing surfaces S1 and S2 and the support surface 13S come into close contact over the entire surface. Due to this, as shown in FIG. 2, the permeation area at the low pressure LS side where the carbon dioxide gas G permeates through the O-ring 11 becomes infinitely small. As a result, the amount of leakage of the carbon dioxide gas G to the low pressure LS side can be made infinitely smaller.

Note that the principle that the gas permeation area can be made smaller to reduce the amount of gas leakage will be explained later.

As described above, in the connector device 1 according to the first embodiment, even when using a rubber O-ring 11 comprised of a material through which carbon dioxide gas may permeate, a first sealing effect is exhibited by the O-ring 11 deformed by the pressing action of the pressurized carbon dioxide gas. Further, the backup ring 13 is moved along the tapered surface 19T by the pressing action of the O-ring 11. Further, the sealing surfaces S1 and S2 are brought to a closed state to form a state not allowing the permeation of carbon dioxide gas due to a second sealing effect due to the elastic deformation expanding it in the diametrical direction of the backup ring 13. Naturally, since the backup ring 13 is formed by a material not allowing permeation of carbon dioxide gas through it, it is possible to make the amount of the carbon dioxide gas which passes through the clearance 20 between the inner wall of the third hollow part 73 of the housing 17 and the shaft 19 located on the low pressure LS side behind the groove 19G and leaked to the outside of the connection members 7 and 9 very small or prevent the leakage.

Experiment

According to an experiment using 80° C. or 40° C. and 15 MPa carbon dioxide gas, both when producing the O-ring 11 by a material allowing easy permeation of pressurized carbon dioxide gas through it and when producing the O-ring 11 by a material resistant to permeation of pressurized carbon dioxide gas through it, there was no change in the amount of leakage of the pressurized carbon dioxide gas. Accordingly, the gas seal performance was higher in the backup ring 13 used as the second gas seal member than the O-ring 11 used as the first gas seal member.

As explained above, the pressurized carbon dioxide gas used as the refrigerant is not only pressurized, but usually is heated to for example 40 to 80° C. For this reason, the backup ring 13 is also heated and easily deforms, the elastic deformation is advanced, and the closeness of contact between the first sealing surface S1 and the second sealing surface S2 is further enhanced. As a result, it is estimated that the sealing effect by the backup ring 13 is further promoted.

When carrying out the present embodiment, it is not necessary to form a particularly complex structure as the groove 19G of the shaft 19. Further, a particularly complex procedure is not necessary. Therefore it is possible to simply and easily make the amount of leakage of the carbon dioxide gas small or substantially eliminate it.

Further, the structure of the connector device of the present embodiment is simple, and it is possible to use a general use O-ring, so it is also possible to suppress any rise of costs.

### Modification of First Embodiment

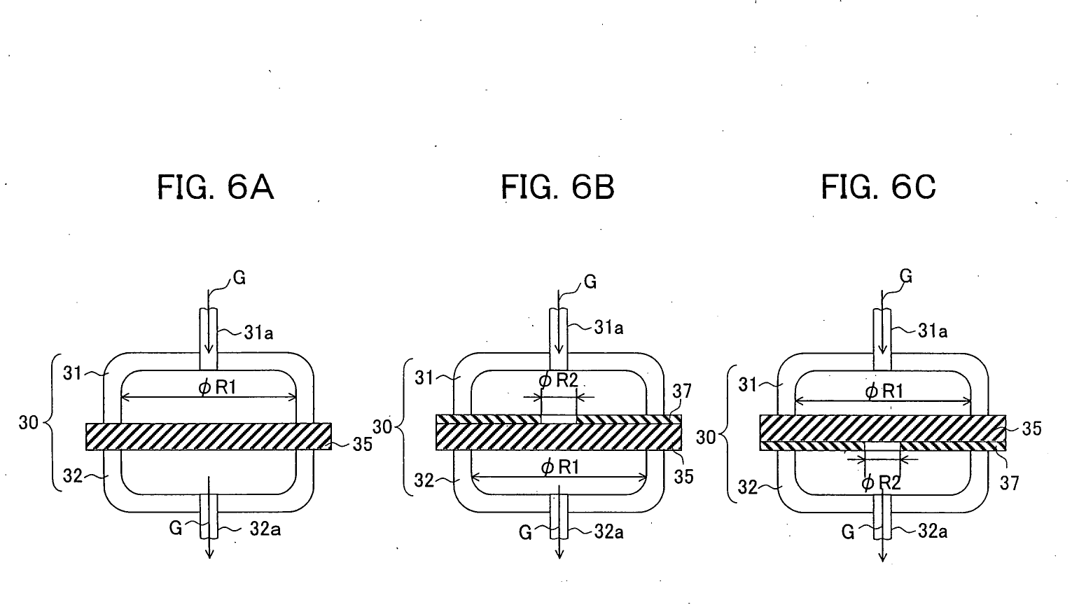

The first embodiment illustrated the case where the groove 19G was formed on the shaft 19 side, but as illustrated in for example FIGS. 5A and 5B, a groove the same as that described above may also be constituted when two half grooves are combined.

In FIG. 5A, a first half groove 19G1 formed in a shaft 19a has a flat bottom 19B, a tapered surface 19T, and walls 19W11 and 19W21. The bottom 19B and the tapered surface 19T are the same as those in the groove 19G illustrated in FIG. 2, but the heights of the walls 19W11 and 19W21 are lower than those of the walls 19W1 and 19W2 illustrated in FIG. 2 by for example about a half. Namely, the depth of the first half groove 19G1 is shallower than the depth of the groove 19G by for example about a half. On the other hand, a second half groove 17G1 is formed in the inner wall of the housing 17a. The second half groove 17G1 is constituted by a wall 17W having about the same height as that of the wall 19W21 and a bottom 17B. When the shaft 19a is inserted into the third hollow part 73 of the housing 17a, the positions of the first half groove G19G1 and the second half groove 17G1 in the axial direction coincide as illustrated in FIG. 5A and substantially the same groove as the groove 19G illustrated in FIG. 2 is defined. The first half groove 19G1 of the shaft 19a is fit with the backup ring 13 and the O-ring 11 in advance.

In FIG. 5B, a second half groove 17G2 is formed on the inner wall of the housing 17b. The second half groove 17G2 is constituted by a wall 17T having about the same depth (height) as that of the wall 19W21 of FIG. 5B, a tapered surface 17T the same as the tapered surface 19T, and a bottom 17B. The groove 19G1 formed in the shaft 19b is the same as that of FIG. 5A. When the shaft 19b is inserted into the third hollow part 73 of the housing 17B, the positions of the first half groove 19G1 and the second half groove 17G2 in the axial direction coincide as illustrated in FIG. 5B and substantially the same groove as the groove 19G illustrated in FIG. 2 is defined. On the first half groove 19G1 of the shaft 19b, the backup ring 13, and the O-ring 11 are previously mounted. Note that, in the second half groove 17G2 illustrated in FIG. 5B, the tapered surface 17T is formed, therefore the circumferential edge portion contacting the tapered surface 17T of the backup ring 13 is not the flat surface as illustrated in FIG. 2 and FIG. 3A and is inclined in the same way as the surface contacting the tapered surface 19T.

As clear also from the above illustration, a groove corresponding to the groove 19G can be formed in either of the shaft 19 or the housing 17 or both of the shafts 19a and 19b and both of the housings 17a and 17b.

Confirmation Experiment

Below, a confirmation experiment for examining the correlation between the clearance 20S and the leakage amount of the carbon dioxide gas will be explained.

Before the confirmation experiment, first, the relationship between the gas permeation area of the O-ring 11, the backup ring 13, or other seal member and the amount of gas leakage will be explained.

Here, the gas permeation area means the area in the surface area of the seal member by which the gas permeating through the inside of the seal member can be discharged out of the seal member.

When the type of gas, pressure P, temperature T, gas permeation coefficient P₀ of the seal member, and the shape of the part through which the gas permeates are determined, it is possible to estimate the amount of gas leakage GL according to the following Equation (1):
GL=(Gmol/k)×P₀×(t×S×P(Pa)/D) (1)

where,

GL: amount of gas leakage (g),

Gmol: molecular weight of the gas (g/mol),

K: coefficient,
K=22410 (cm³(STP)/mol),

P₀: gas permeation coefficient when the pressure P(Pa) and the temperature T are constant,

t: transmission time (second),

S: permeation area (cm²)

P(Pa): pressure at that time, and

D: permeation distance (cm)

STP in Equation (1) represents a standard state (temperature 0° C., 1 atm).

Further, the gas permeation coefficient P₀ is a coefficient indicating the gas permeation characteristic of the seal member converted to units according to the following Equation (2):
Pₒ=(Gt/t)×(D/((S×P(Pa)) (2)

where, Gt: amount of gas permeation (cm² (STP))

It is seen from the above Equation (1) that the smaller the permeation area, the smaller the amount of gas leakage GL too.

Here, based on the Method A (Differential Pressure Method) of the Gas Permeation Test Method of Plastic Film and Sheet of JIS K7126, the carbon dioxide gas permeation characteristic of a sheet-shaped seal member made of a rubber material, for example, the O-ring 11, was checked. At this time, the amount of gas leakage was not directly found, but the amount of gas permeation of the sheet-like seal member was examined. It is seen from Equation (1) and Equation (2) that the gas permeation coefficient P₀ becomes large when the amount of gas permeation is large and consequently also the amount of gas leakage increases.

Details will be described below.

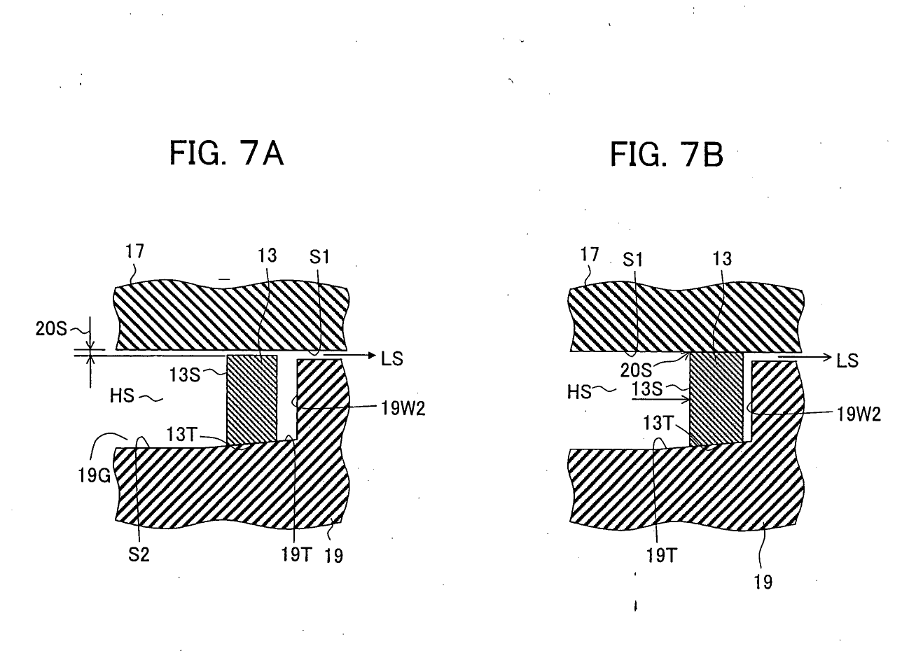

FIGS. 6A to 6C are schematic views of the configuration of principal parts of a gas permeation measurement device used for the measurement of the amount of permeation of carbon dioxide gas.

The gas permeation measurement device and the measurement method are disclosed in JIS K7126, therefore only a simple description is given here, but the gas permeation measurement device has a permeation cell 30 constituted by an upper cell 31 and a lower cell 32 as shown in FIG. 6A.

In the upper cell 31 and the lower cell 32, the inner circumferential surfaces of connection parts have circular shapes with inside diameters R1. The size of the inside diameter R1 was set to 70 mm here.

Further, the upper cell 31 is connected to a not illustrated test gas feeder and has an inlet 31a through which the carbon dioxide gas G used as the test gas is introduced. The lower cell 32 is connected to a not illustrated pressure detector and has an outlet 32a through which the carbon dioxide gas G permeated through a test piece 35 is discharged.

The test piece 35 is mounted between the upper cell 31 and the lower cell 32 so as to seal between the upper cell 31 and the lower cell 32.

As the test piece 35, a sheet of butyl rubber was used. The thickness of the butyl rubber sheet 35 was set to for example 0.3 mm.

FIG. 6B shows a case where an aluminum sheet 37 having an opening with a diameter R2 formed at the center is arranged on the surface of the upper cell 31 side. Both of the aluminum sheet 37 and the butyl rubber sheet 35 are sandwiched by the upper cell 31 and the lower cell 32 in addition to the configuration shown in FIG. 6A.

FIG. 6C shows a case where the aluminum sheet 37 is arranged on the surface of the lower cell 32 side, and both of the aluminum sheet 37 and the butyl rubber sheet 35 are sandwiched by the upper cell 31 and the lower cell 32.

The diameter R2 of the opening of the aluminum sheet 37 was set to 10 mm in both of the cases of FIGS. 6B and 6C.

Under the above conditions, after evacuating the permeation cell 30, 70° C. carbon dioxide gas was introduced into the upper cell 31 at about 101325 Pa (1 atmosphere), and the amount of permeation of the carbon dioxide gas G in the lower cell 32 was measured.

As a result thereof, in the case of FIG. 6A, the amount of permeation became 2.3 cm³·mm/24 h·101325 Pa per 1 mm thickness of the butyl rubber sheet 35. Further, in the case of FIG. 6B, in the same way as the case of FIG. 6A, it was 2.3 cm³·mm/24 h·101325 Pa. Further, in the case of FIG. 6C, it was 1/10 of the case of FIG. 6A or 0.23 cm³·mm/24 h·101325 Pa.

Even when the aluminum sheet 37 is provided in the high pressure upper cell 31 as illustrated in FIG. 6B, the amount of gas permeation is the same as that of the case of FIG. 6A where there is no aluminum sheet 37. On the other hand, by providing the aluminum sheet 37 on the lower cell 32 side with a low pressure as illustrated in FIG. 6C, the amount of gas permeation becomes 1/10 of the case of FIG. 6A.

It is seen from the above description that, in order to reduce the amount of gas permeation, it is not effective to narrow the gas entry area through which the gas enters the seal member made of rubber (butyl rubber sheet 35), but it is effective to narrow the outlet of the gas for discharging the gas permeated through the inside of the seal member by the aluminum sheet 37. Namely, as shown in FIG. 6C, the aluminum sheet 37 at the outlet of the butyl rubber sheet 36 narrows the gas permeation area.

Accordingly, in the connector device 1 explained by referring to FIG. 1 to FIG. 5, by reducing the size of not the flat bottom 19B for introducing the pressurized gas, but the clearance 20S of the tapered surface 19T portion performing the same function as that of the aluminum sheet 37, it is possible to make the permeation area of the O-ring 11 as small as possible. Namely, it is seen that the reduction of size of the clearance 20S is effective for preventing the leakage of the carbon dioxide gas through the O-ring 11 and the backup ring 13 to the outside of the connection members 7 and 9.

Consider the effect by using the tapered surface 19T and combining the O-ring 11 as the first gas seal member and the backup ring 13 as the second gas seal member. The O-ring 11 alone maintains the inside and the outside of the connector device 1 in the sealed state in the state when the inside of the connector device 1 is at the atmospheric pressure state and prevents the leakage of the pressurized gas to a certain extent when the inside of the connector device 1 is in a high pressure state. On the other hand, the backup ring 13 may move away from the inner wall of the housing 17 in the atmospheric pressure state and the contact with the tapered surface 19T is weak, therefore there is no guarantee that the sealed state can be maintained. Accordingly, in the above high pressure state, the diameter is enlarged at the inner walls of the tapered surface 19T and the housing 17, the first sealing surface S1 and the second sealing surface S2 are sealed, and in addition to the gas seal of the O-ring 11, the leakage of the pressurized carbon dioxide gas is prevented. Namely, by the reduction of size of the sectional area on the low pressure LS side of the O-ring 11 by the backup ring 13, the effect of sealing the pressurized carbon dioxide gas remarkably increases in the O-ring 11 per se. In this way, the sealing property of the connector device 1 is remarkably improved by cooperation of the O-ring 11 as the first gas seal member, the backup ring 13 as the second gas seal member, and a region defined on the inner walls of the tapered surface 19T and the housing 17. In this way, by combining the O-ring 11 and the backup ring 13 under the existence of the tapered surface 19T, a synergistic effect as a gas sealing means is exhibited.

Backup Ring and Sealing Surface

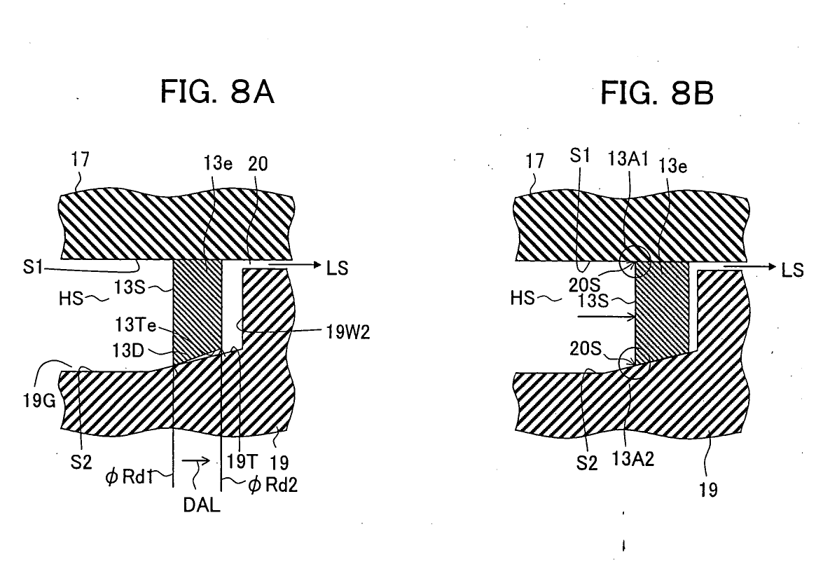

In order to make the clearance 20S as small as possible, it is necessary to suitably fit the backup ring 13 between the sealing surfaces S1 and S2. Below, the relationship between the tapered surface 19T of the groove 19G of the shaft 19 and the clearance 20S will be explained in detail by referring to FIGS. 7A and 7B.

FIGS. 7A and 7B are partially enlarged views showing principal parts of the connector device 1 in the same way as the illustration of FIG. 2. The same notations are attached to the same components as the components shown in FIG. 2, and detailed descriptions will be omitted. Note, in FIGS. 7A and 7B, the illustration of the O-ring 11 is omitted.

FIG. 7A shows a state of the backup ring 13 fit in the groove 19G of the shaft 19 in a state of atmospheric pressure where no carbon dioxide gas flows at ordinary (normal) ambient temperature and the O-ring 11 does not press against the backup ring 13.

For example, the backup ring 13 is formed so that the outside diameter of the backup ring 13 when fit on the lower portion of the tapered surface 19T away from the wall 19W2 does not contact the inside diameter of the housing 17. Further, as previously described, the inner circumferential side of the backup ring 13 contacting the tapered surface 19T is formed with a tapered surface 13T having the same inclination as the inclination of the tapered surface 19T and annular in shape.

The backup ring 13 having the tapered surface 13T having the same inclination as that of the tapered surface 19T is fit on the tapered surface 19T part of the groove 19G. In a state where pressurized carbon dioxide gas does not flow and the O-ring 11 does not press against the backup ring 13 along the tapered surface 19T on the right side in FIG. 7A, a small clearance 20S exists between the sealing surfaces S1 and S2 and the support surface 13S of the backup ring 13. Assume that the size of this clearance 20S is for example 0.05 mm.

When the carbon dioxide gas flows, the backup ring 13 is pressed against the right side in FIG. 7A, via a not illustrated O-ring from the high pressure HS side in the inside of the connector device 1 toward the low pressure LS side communicated with the outside of the connector device 1. As a result, as shown in FIG. 7B, the backup ring 13 moves to the low pressure LS side (toward the wall 19W2) on the tapered surface 19T, and the circumferential edge portion of the backup ring 13 contacts the inner wall of the housing 17. In some cases, the backup ring 13 abuts against the wall 19W2.

At this time, by the movement suppressing action of the inner wall of the housing 17 and the tapered surface 19T, along with movement of the backup ring 13 to the low pressure LS side, the backup ring 13 is compressed, and the clearance 20S becomes small (narrow). Further, the wall 19W2 has the action of suppressing the movement of the backup ring 13 when the backup ring 13 abuts against the wall 19W2.

However, where the inclinations of the tapered surface 19T of the groove 19G and the tapered surface 13T of the backup ring 13 are the same and there is the clearance 20S in the state where the carbon dioxide gas does not flow, the pressing force to the backup ring 13 by the O-ring 11 derived from the deformation of the O-ring 11 due to the pressing force from the carbon dioxide gas is transformed to stress mainly reducing the diameter of the backup ring 13. For this reason, the clearance 20S becomes narrow, but almost no stress compressing the backup ring 13 to an extent that the pressurized carbon dioxide gas is sufficiently sealed between the sealing surfaces S1 and S2 is generated along with movement of the backup ring 13 to the low pressure LS side.

The relationship between the tapered surface 19T between the sealing surfaces S1 and S2 and the ring-like tapered surface 13T of the backup ring 13 is made that shown in FIG. 7A, and the backup ring 13 is formed by for example 46Nylon. Further, for example, at ordinary temperature, the 6.5 MPa carbon dioxide gas flows to the high pressure HS side.

At this time, the size of the clearance 20S in a state where the distance between the sealing surfaces S1 and S2 and the support surface 13S of the backup ring 13 became narrower as shown in FIG. 7B was 0.99×10⁻³ mm. When there is a clearance 20S having a size of this degree, leakage of the carbon dioxide gas occurs.

In this way, it is not possible to make the clearance 20S approach zero as much as possible by just providing tapers making the inclinations of the tapered surface 19T and the ring-like tapered surface 13T the same between the tapered surface 19T of the groove 19G and the backup ring 13.

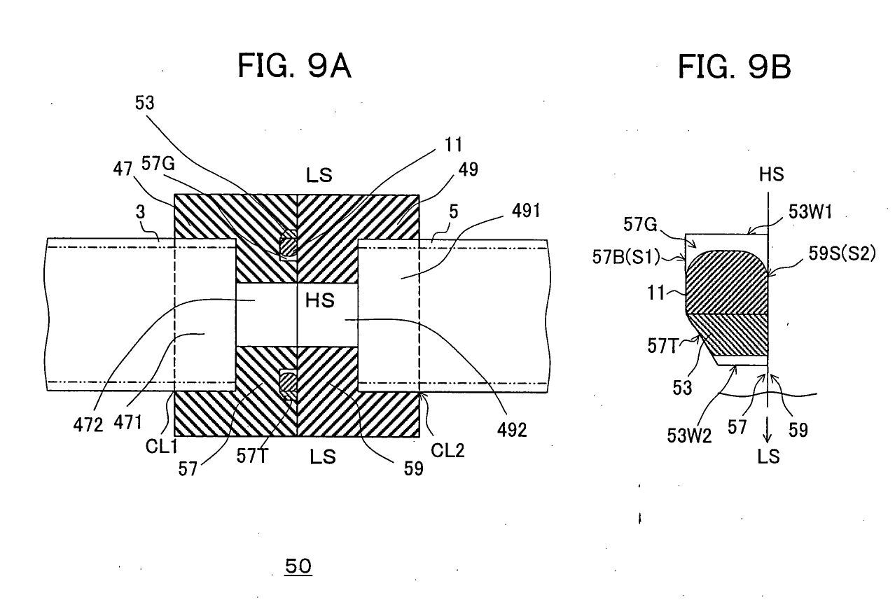

In order to reduce the clearance 20S as much as possible, for example, it is necessary to form the backup ring and sealing surfaces S1 and S2 having the configurations shown in FIGS. 8A and 8B.

FIGS. 8A and 8B are partially enlarged views showing principal parts of the connector device 1 in the same way as the illustration of FIGS. 7A and 7B, FIG. 8A shows a state where the carbon dioxide gas does not flow, and FIG. 8B shows a state where the backup ring 13e is pressed by the carbon dioxide gas. Note that, in FIGS. 8A and 8B, the illustration of the O-ring 11 is omitted.

The backup ring 13e shown in FIGS. 8A and 8B is different in inclination of the tapered surface contacting the tapered surface 19T from the ring-like tapered surface 13T of the backup ring 13 shown in FIGS. 7A and 7B.

The components other than the backup ring 13e shown in FIGS. 8A and 8B are the same as the components shown in FIG. 2 and FIGS. 7A and 7B, therefore the same notations (references) are attached to the same components, and detailed descriptions will be omitted.

As shown in FIG. 8A, on the inner circumferential side of the backup ring 13e contacting the tapered surface 19T of the groove 19G, a ring-like tapered surface 13Te is formed having an inclination by which the end on the high pressure HS side contacts the tapered surface 19T and the end on the low pressure LS side does not contact the tapered surface 19T in a state where an inside diameter Rd2 on the low pressure LS side is smaller than an inside diameter Rd1 on the high pressure HS side and the pressurized carbon dioxide gas does not flow. Namely, the inclination of the tapered surface 13Te is made larger than the inclination of the tapered surface 19T of the sealing surface S2.

When such a backup ring 13e is fit on the tapered surface 19T part of the groove 19G, the inner circumferential side of the backup ring 13e contacting the tapered surface 19T is formed with a clearance enlarged from the high pressure HS side toward the low pressure LS side. A tapered surface 13D of the end on the high pressure HS side of the tapered surface 13Te of the backup ring 13e becomes a “crush margin” for crushing along with the movement of the backup ring 13e to the low pressure LS side due to the pressurized carbon dioxide gas.

When the pressurized carbon dioxide gas flows, as shown in FIG. 8B, the backup ring 13e is pressed from the high pressure HS side toward the low pressure LS side and moves to the low pressure LS side. By the movement of the backup ring 13e to the low pressure LS side, compressive stress is partially applied to the high pressure side of the backup ring 13e in the regions 13A1 and 13A2 contacting the inner wall of the housing 17 and the tapered surface 19T illustrated in FIG. 8B.

In this way, compressive stress is partially generated due to the difference of inclinations of the tapered surface 13Te and the tapered surface 19T, therefore even when a pressing force the same as that of the first embodiment is applied, the backup ring 13e strongly contacts the sealing surfaces S1 and S2 by the backup ring 13 shown in FIG. 7B. As a result, it is possible to reduce the clearance 20S as much as possible.

For example, a crush margin 13D was provided on the high pressure HS side as shown in FIG. 8A by the 46Nylon to form a backup ring 13e, and 6.5 MPa carbon dioxide gas was made to flow to the high pressure HS side at ordinary temperature in the same way as the test of the backup ring 13 in FIG. 7A. As a result, the clearance 20S on the high pressure HS side became small to an extent where measurement was impossible and it became possible to reduce the leakage of the carbon dioxide gas to the low pressure LS side as much as possible.

As described above, by making the inclinations of the tapered surface 13Te of the backup ring 13e and the tapered surface 19T of the groove 19G different, specifically, by making the inclination of the tapered surface 13Te larger than the inclination angle of the tapered surface 19T, the end on the high pressure side of the tapered surface 13e is partially compressed in the axial direction along with the movement to the low pressure LS side. By the compression of the backup ring 13e between the sealing surface S1 and the sealing surface S2, the compressed part of the backup ring 13e expands in the diametrical direction and strongly contacts the sealing surfaces S1 and S2.

As shown in FIG. 8A, when providing the crush margin 13D on the high pressure HS side of the backup ring 13e, the clearance 20S on the high pressure HS side approaches zero, therefore there is no possibility of the O-ring 11 pressed by the pressurized carbon dioxide gas entering into the clearance 20S, the load with respect to the deformation of the O-ring 11 is reduced, and it is possible to prevent the deformation of the O-ring 11.

In FIGS. 8A and 8B, an example of providing the crush margin 13D on the inside diameter side of the backup ring 13e contacting the tapered surface 19T was shown, but conversely it is also possible to provide a “crush margin” on the outer circumferential side of the backup ring 13e contacting the third hollow part 73 of the housing 17. In this way, it is possible to suppress the gas leakage by providing the “crush margin” at either of the inner circumferential side or outer circumferential side of the backup ring, but it is possible to further reduce the amount of gas leakage by providing the “crush margins” at both of the inner circumferential side and the outer circumferential side.

Note that, in FIGS. 8A and 8B, the inclinations of the tapered surface 13Te and the tapered surface 19T were set so that partial compression was generated in the backup ring 13e on the high pressure HS side. However, by modifying the shapes of the housing 17, groove 19G, and backup ring 13e, it is also possible to uniformly compress the backup ring 13e along an axial direction DAL of the shaft 19. By uniformly compressing the backup ring 13e between the sealing surfaces S1 and S2, it is possible to further reduce the amount of gas leakage to the low pressure LS side.

The roles of the O-ring 11 used as the first gas seal member and the backup ring 13 used as the second gas seal member and the role of the tapered surface 19T will be described next in more detail.

The O-ring 11 by itself maintains the insides and the outsides of the connector device 1 in the sealed state in a low pressure state of the inside of the connector device 1 equivalent to the atmospheric (ambient) pressure since the pressurized gas does not pass through the first pipe 3 and the second pipe 5, while prevents the leakage of the pressurized gas to a certain extent when the pressurized gas passes through the first pipe 3 and the second pipe 5 and the insides of the connector device 1 become a high pressure state.

On the other hand, while there is no guarantee that the backup ring 13 can maintain the sealed state in the above low pressure state, in the above high pressure state, it becomes enlarged in diameter on the inner walls of the tapered surface 19T and the housing 17, so seals the first sealing surface S1 and the second sealing surface S2 and prevents the leakage of the pressurized carbon dioxide gas in addition to the gas sealing of the O-ring 11.

Further, by the reduction of the sectional area on the low pressure LS side of the O-ring 11 by the backup ring 13, the pressurized carbon dioxide gas sealing effect increases in the O-ring 11 per se.

In this way, by the action of the O-ring 11 used as the first gas seal member, the backup ring 13 used as the second gas seal member, and the region defined on the inner walls of the tapered surface 19T and the housing 17, the sealing property of the connector device 1 is remarkably improved.

In this way, each of the O-ring 11 used as the first seal member and the backup ring 13 used as the second gas seal member has a different role. The materials thereof are also different. However, by combining the O-ring 11 and the backup ring 13 under the existence of the tapered surface 19T, a synergistic effect is exhibited as the gas sealing means.

### Second Embodiment

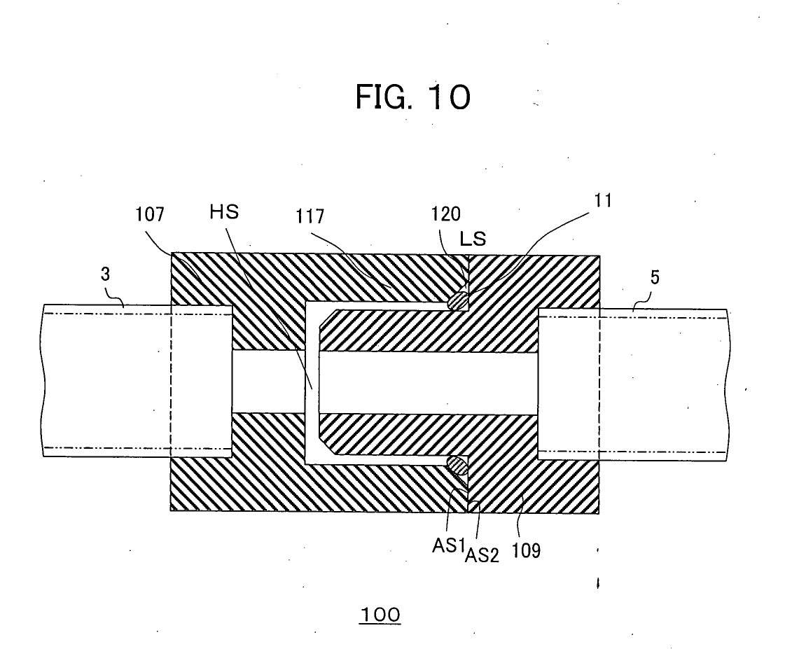

FIGS. 9A and 9B will be referred to next to describe a second embodiment of the present invention.

FIG. 9A is a sectional view showing a connector device 50 according to the second embodiment of the present invention. FIG. 9B is a partially enlarged view of FIG. 9A.

The connector device 1 according to the first embodiment had a structure of a cylindrical surface seal sealing the clearance between the housing 17 and the cylindrical surface of the shaft 19, but the second embodiment has a structure sealing the end surfaces of the first connection member 7 and the second connection member 9.

The connector device 50 of the second embodiment uses a first connection member 47 in place of the first connection member 7 in the first embodiment uses a second connection member 49 in place of the second connection member 9, and uses a backup ring 53 in place of the backup ring 13. As the O-ring, use is made of an O-ring 11 the same as the case of the connector device 1. Note that it is also possible to use an O-ring different from the O-ring 11 in accordance with the type of the gas flowing in the connector device 50 and the shape of the seal part of the connection member.

The connection member 47 connected to the pipe 3 and the connection member 49 connected to the pipe 5 are connected to each other. The function of the connection members 47 and 49 of carrying pressurized carbon dioxide gas in the flow path inside the connector device 50 is the same as the case of the first embodiment.

The first pipe 3 is fit in a first hollow part 471 of the connection member 47, and the end outer surface CL1 is connected by for example welding. In the same way as the above, the second pipe 5 is fit in a third hollow part 491 of the connection member 49, and the end outer surface CL2 is connected by for example welding.

The connection member 47 is provided with a first flange 57, while connection member 49 is provided with a second flange 59. The flange 57 and the flange 59 are provided so as to face and contact each other when connecting the connection member 47 and the connection member 49.

The connection member 47 is provided with a second hollow part 472 communicating with the surface of the flange 57 and the first hollow part 471, while the connection member 49 is provided with a fourth hollow part 492 communicating with the surface of the flange 59 and the third hollow part 492. When the surface of the flange 57 and the surface of the flange 59 are made to face and contact each other, the second hollow part 472 and the fourth hollow part 492 communicate with each other. The second hollow part 472 and the fourth hollow part 492 have the same inside diameters.

As illustrated enlarged in FIG. 9B, the flange 57 of the connection member 47 is formed with a groove 57G and a tapered surface 57T.

The tapered surface 57T, in the same way as the tapered surface 19T in the case of the first embodiment, is formed continuing from a flat bottom 57B of the groove 57G and so that the groove becomes shallower toward the low pressure LS side of the outside of the connection member 47 and the connection member 49.

The O-ring 11 is fit on the bottom 57B of the groove 57G. In the connector device 50, the O-ring 11 seals the sealing surfaces, defining the bottom 57B of the groove 57G as the first sealing surface S1 and defining a surface 59S of the flange 59 facing this bottom as the second sealing surface S2, when connecting the connection member 47 and the connection member 49 by contact of the surface of the flange 57 and the surface of the flange 59.

The backup ring 53 is easily fit on the groove 57G of the flange 57 in the present embodiment, therefore preferably is formed as a perfect ring shape similar to the illustration of FIG. 3B. The backup ring 53 is arranged in the groove 57G so as to support the outer circumference of the O-ring 11 by the support surface constituted by its inner circumferential surface. Accordingly, the backup ring 53 is arranged on a lower pressure side than the O-ring 11 as illustrated in FIG. 9B.

The backup ring 53 is formed by using a plastic or polymer material resistant to permeation of carbon dioxide gas the same as the material described as the material of the backup ring 13 used in the first embodiment and has a tapered surface matching with the tapered surface 57T or a tapered surface having a larger inclination angle than the inclination of the tapered surface 57T. The advantage in the case where the tapered surface of the backup ring 13 has a larger inclination angle than the inclination of the tapered surface 57T is as described above with reference to FIGS. 8A and 8B.

By the above configuration, it is possible to realize a seal structure at the end face connecting the surface of the flange 57 and the surface of the flange 59.

When connecting the connection members 47, 49 and carrying pressurized gas in the pipes 3, 5, in the same way as the case of the first embodiment, by receiving the pressure difference between the high pressure HS side of the inside and the low pressure LS side of the outside of the connection members 47 and 49, the O-ring 11 is pressed to the low pressure LS side. As a result, the backup ring 53 pressed by the O-ring 11 via the support surface of the backup ring 53 moves to the low pressure LS side and resiliently deforms so that, due to the tapered surface 57T, the clearance between the sealing surface and the support surface of the groove 57G and the flange 59 becomes narrow.

By this, the gas permeation area of the O-ring 11 on the low pressure LS side becomes smaller without limit, and it is possible to reduce the leakage of the carbon dioxide gas to the low pressure LS side without limit.

In the second embodiment, it is also possible to not only form the groove 57G in one flange 57, but also form a groove the same as the groove 57G in the other flange 59.

Further, in the second embodiment, as illustrated by referring to FIG. 5A and FIG. 5B, it is also possible to form half grooves in the two flanges 57 and 59 to thereby form a groove equivalent to the groove 57G described above when combining the two flanges 57 and 59.

As described above, even in the case of an end surface seal structure, it is also possible to greatly reduce the leakage of the carbon dioxide gas to the low pressure LS side.

In this way, in the second embodiment as well, the same effect as that of the case of the first embodiment can be obtained.

Further, even in the case of the end surface seal structure of the second embodiment, the effect can be obtained that it is possible to simplify the shape of the connection member in comparison with the case of the first embodiment and therefore the cost can be reduced.

### Third Embodiment

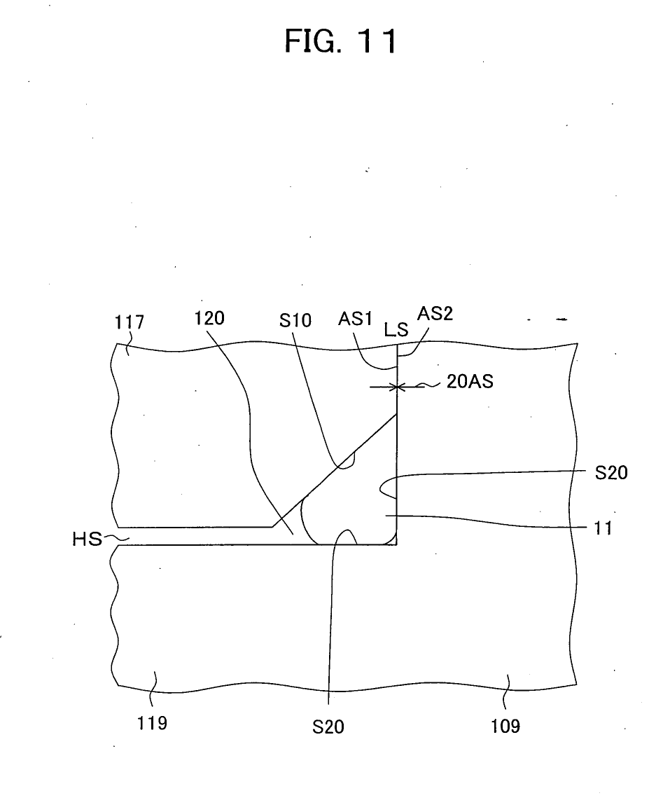

FIG. 10 and FIG. 11 will be referred to so as to describe a third embodiment of the present invention.

FIG. 10 is a sectional view showing a connector device and a seal device according to a third embodiment of the present invention. FIG. 11 is a schematic partially enlarged view of the principal parts thereof.

A connector device 100 according to the third embodiment is a connector device for preventing leakage of the carbon dioxide gas by only an O-ring 11 without using a backup ring as in the first and second embodiments.

The connector device 100 does not have a backup ring. Further, the shapes of a connection member 107 and a connection member 109 used as the first and second connection members of the present invention are different from those of the first embodiment. The rest of the configuration is the same as that of the first embodiment, so a detailed description will be omitted here.

A shaft 119 of the connection member 109 does not have a groove in which the O-ring 11 is fit. In place of this, a first abutting surface AS1 and a second abutting surface AS2 abutting against each other when they are connected are provided at the connection member 107 and the connection member 109.

The first abutting surface AS1 of the connection member 107 is provided as a surface facing the connection member 109 at the front end of a housing 117. Further, the second abutting surface AS2 of the connection member 109 becomes the surface serving as the base on which the shaft 119 is provided.

An inner wall corner of the front end of the housing 117 is chamfered (cut) so as to exhibit a triangular shape so that the sectional shape of a groove 120 becomes narrower toward the abutting surfaces AS1 and AS2. In this way, in the present embodiment, by the same method as the first embodiment, the inner wall corner of the front end of the housing 117 of the connection member 107 is chamfered (cut) so that the groove 120 of the second part continuing from the abutting surfaces AS1 and AS2 is formed when connecting the connection members 107 and 109. The front end of the housing 117 is cut, and the part with the triangular cross section in which the O-ring 11 is held is defined as the groove of the first part.

The cut portion in which the O-ring 11 is held and the groove 120 of the second part defined by the first abutting surface AS1 and the second abutting surface AS2 correspond to the groove of the present invention, that is, an embodiment of the holding part of the gas sealing means.

The chamfered surface (cut surface) of the housing 117 becomes a sealing surface S10 of the connection member 107. Further, the two surfaces other than the sealing surface S10 of the groove 120 having a triangular sectional shape become a sealing surface S20 of the connection member 119.

The O-ring 11 seals between the sealing surface S10 of the connection member 107 and the sealing surface S20 of the connection member 109.

By the above configuration, when connecting the connection members 107 and 109 by the same method as that of the first embodiment, the abutting of the abutting surface AS1 and the abutting surface AS2 against each other causes a clearance 20AS on the low pressure LS side of the O-ring 11 to approach zero.

By the groove 120 pressing against the O-ring 11 by the sealing surface S10 and the sealing surface S20 and further the pressure of gas acting upon the O-ring 11, the O-ring 11 is resiliently deformed so as to fill the clearance between the abutting surfaces AS1 and AS2 and the sealing surfaces S10 and S20. Due to this, the gas permeation area of the O-ring 11 on the low pressure LS side becomes smaller without limit, and in addition to the certain extent of the gas permeation prevention function of the O-ring 11 per se, the amount of leakage of the carbon dioxide gas can be remarkably reduced.

As described above, by the third embodiment as well, it is possible to reduce the amount of leakage of the pressurized carbon dioxide gas to the low pressure LS side as much as possible.

When carrying out the third embodiment, since the backup ring is not necessary, it is possible to further simply and easily prevent the leakage of the carbon dioxide gas compared with the above-explained embodiments. Further, the cost of the connector device is further lowered compared with the above embodiments.

### Fourth Embodiment

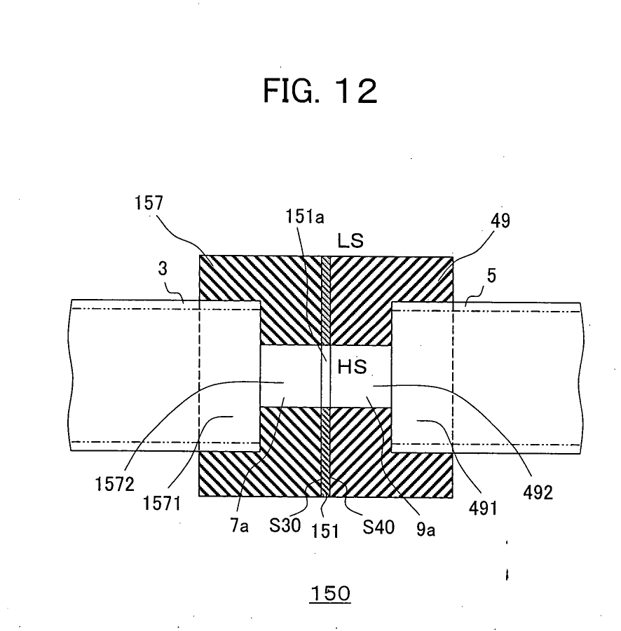

FIG. 12 will be referred to so as to describe a fourth embodiment of the present invention.

FIG. 12 is a sectional view showing a connector device and a seal device according to the fourth embodiment of the present invention.

A connector device 150 according to the fourth embodiment is a connector device for sealing by using not an O-ring, but a sheet-shaped seal member 151 as the seal member.

The connector device 150 has a first connection member 157, a second connection member 49 the same as the connection member used in the second embodiment, and a sheet-shaped seal member 151. The rest of the components are the same as those of the second embodiment, so detailed descriptions will be omitted.

In the same way as the second embodiment, a first pipe 3 is fit in a first hollow part 1571 and connected to the connection member 157. In the same way, a second pipe 5 is fit in a third hollow part 491 and connected to the connection member 49.

The connection member 157 and the connection member 49 have a first sealing surface S30 and a second sealing surface S40 facing each other when connected. The sealing surfaces S30 and S40 are flat surfaces.

The connection member 157 and the connection member 49 are formed by a material not allowing permeation of carbon dioxide gas or a material resistant to the same in the same way as the connection members 7 and 9 in the first embodiment.

The seal member 151 has the same diameter as a second hollow part 1572 and the fourth hollow part 492, communicates the second hollow part 1572 and the fourth hollow part 492, and is formed to a thin sheet shape having an opening 151a for flow of the carbon dioxide gas. It is comprised by a plastic sheet or a metal gasket coated thinly with rubber on both surfaces. The surfaces on the two sides of the sheet-shaped seal member 151 become the sealing surfaces.

As the material of the plastic used for the seal member 151, use can be made of for example a polyacrylonitrile resin, polyvinyl alcohol resin, polyamide resin, polyvinyl fluoride resin, high density polyethylene resin, polystyrene resin, PEEK resin, PPS resin, LCP resin, and polyimide resin the same as the material of the backup ring in the above embodiments. The seal member 151 may also be formed by a synthetic polymer material resistant to passage of a gas through it such as 46Nylon.

The sheet-shaped seal member 151 is sandwiched between the connection member 157 and the connection member 49 by communicating the opening 151a with flow paths 7a and 9a defined in the second hollow part 1572 and the fourth hollow part 492 at the time of connection of the pipes 3 and 5 to the connection member 157 and the connection member 49.

By sandwiching the sheet-shaped seal member 151 between the connection member 157 and the connection member 49, the flat sealing surface of the seal member 151 contacts the flat sealing surface S30 and sealing surface S40 and seals a space between the connection member 157 and the connection member 49.

By sealing by sandwiching the sheet-shaped seal member 151 between the connection members 157 and 49, the gas permeation area of the seal member 151 on the low pressure LS side at the outside of the connection members 157 and 49 (connector device 150) becomes small. Further, the gas permeation distance of the carbon dioxide gas permeating through the inside of the seal member 151 and reaching the low pressure LS side of the outside of the connector device 150 from the high pressure HS side of the insides of the connection members 157 and 49 becomes long.

It is seen from Equation (1) that the smaller the gas permeation area and the longer the permeation distance, the smaller the amount of gas leakage.

On the other hand, in the case of a cylindrical surface seal using an O-ring as in the past, the O-ring diameter can be made smaller by reducing the diameter of insertion (fitting), the gas permeation area may be reduced by this, and the gas permeation area may be reduced by the further reduction of the O-ring diameter, but it is difficult to reduce the diameter of insertion more than a certain extent. Further, it is also possible to reduce the permeation area by reducing the thickness of the O-ring (diameter of cross section), but when the thickness is made too small, it becomes difficult to secure the minimum “crush margin” of the O-ring by the pressing action of the pressurized carbon dioxide gas. Accordingly, it is difficult to reduce the linear diameter (diameter) of the O-ring to a certain extent or less. If making the thickness of the O-ring small, the gas permeation distance becomes shorter as well, so there is also a disadvantage of an increase of the amount of gas leakage.

In the present embodiment, by giving a sheet shape to the seal member 151, the disadvantage as described above is solved, and the leakage of the carbon dioxide gas to the low pressure LS side may be greatly reduced.

When carrying out the present embodiment, since the structure of the connector device and the seal member is simple and use may be made of a material the same as that of the O-ring for the seal member, it is possible to easily perform the sealing, it is possible to obtain general applicability, and also the effect of reduction of cost is obtained.

### Fifth to Seventh Embodiments

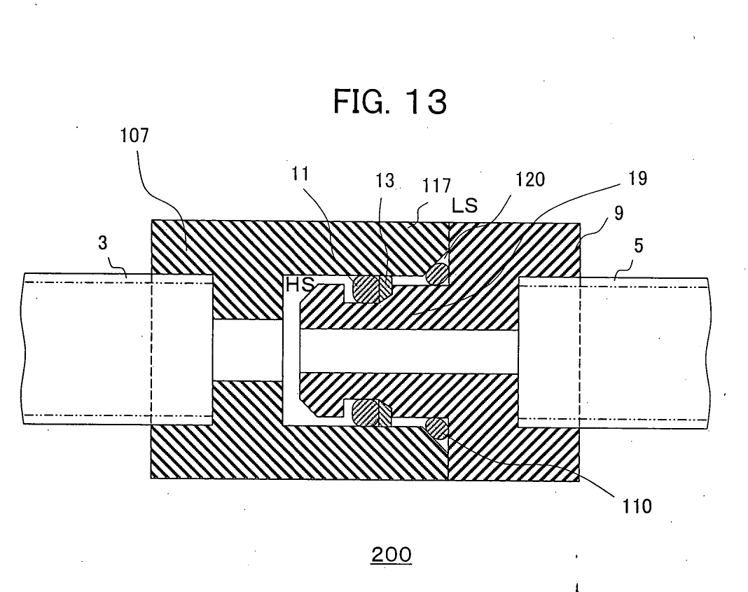

FIG. 13 to FIG. 15 will be referred to so as to describe fifth to seventh embodiments of the present invention.

The first to fourth embodiments may be suitably combined to obtain further higher sealing effects. Examples thereof will be described with reference to FIG. 13 to FIG. 15.

A connector device 200 shown in FIG. 13 is a combination of the first embodiment and the third embodiment. In the connector device 200, the first O-ring 11 and the backup ring 13 in the first embodiment and the second O-ring 110 of the third embodiment are used. Namely, the past two O-rings and backup ring 13 are used. If the first embodiment and the third embodiment are combined in this way, the synergistic effect causes the leakage of the pressurized carbon dioxide gas to become very small.

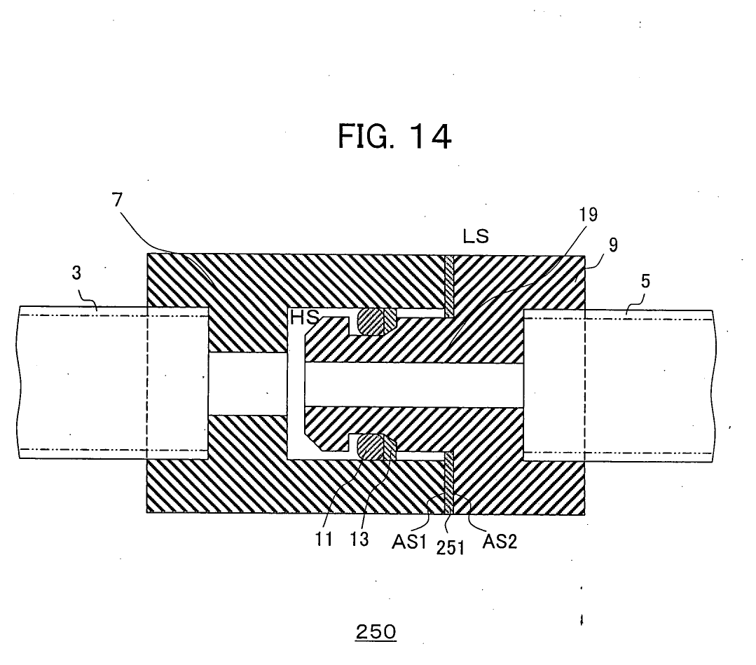

A connector device 250 shown in FIG. 14 is a combination of the first embodiment and the fourth embodiment. However, in place of the seal member 151 in FIG. 12, there is used a sheet-shaped seal member 251 between the end surface at the base end of the shaft 19 of the second connection member 9 and the end surface at the front end of the housing 17 of the first connection member 7. The parts of the O-ring 11 and the backup ring 13 are the same as those of the first embodiment.

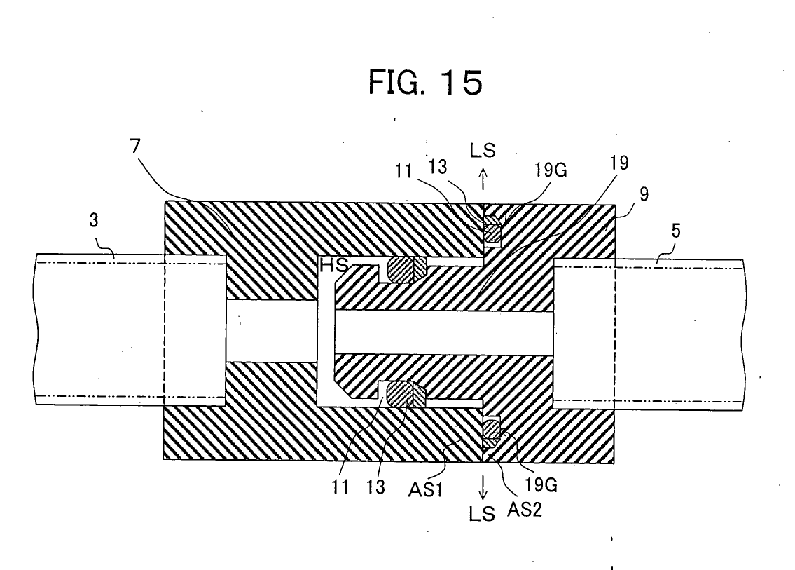

A connector device 350 shown in FIG. 15 is a combination of the first embodiment and the second embodiment. However, the second embodiment is applied to the front end surface of the housing 17 and the end surface of the main body 70.

When combining the first embodiment and the fourth embodiment in this way, the synergistic effect causes the leakage of the pressurized carbon dioxide gas to become very small.

Further, it is also possible to apply the second embodiment explained by referring to FIGS. 9A and 9B in place of the fourth embodiment in which the sheet-shaped seal member 251 is fit between the end surface at the base end of the shaft 19 of the second connection member 9 and the end surface at the front end of the housing 17 of the first connection member 7 illustrated in FIG. 14. As described above, by combining the embodiments of the present invention in various ways, no special device or structure is necessary other than that, and a further higher sealing effect can be obtained.

Further, since it is possible to improve the sealing effect by a relatively simple structure, there is also the effect that the efficiency of the cooling device or other device is raised and costs can be suppressed at that time.

While preferred embodiments of the present invention were described above, the present invention is not limited to the above embodiments.

For example, while the mode of applying the connector device of the present invention to a connection part of pipes was described in the embodiments of the present invention described above, it is also possible to apply the present invention to sealing between other members which gas contacts such as a container into which a gas is sealed and a lid thereof.

Further, in the third embodiment, it is also possible if the sectional shape of the O-ring 351 be made triangular matching with the triangular sectional shape of the groove 120. Also, the shape of the groove 120 is not limited to a triangular sectional shape and may be any shape by which the gas permeation area on the low pressure side of the seal member becomes small. The fact of the shape of the groove being changeable is the same for the case of the connector device 200 shown in FIG. 13.

In the first and second embodiments, when using the backup ring 13e having the crush margin 13D as shown in FIGS. 8A and 8B, it becomes possible to obtain a higher seal property than that the mode of using another seal member such as connector device 200 and connector device 250 together. By this, it is possible to eliminate the trouble of formation of the groove 120 and fitting of the seal member 251 and prevent complication of the structures of the seal device and connector device.

The shape of the clearance narrowing means of the embodiment of the present invention is not limited to a tapered surface such as the tapered surface 19T of the groove 19G of the shaft 19. Further, the position of providing the clearance narrowing means is not limited to the shaft 19. For example, the tapered surface may be provided in the housing 17 as well. So far as the clearance between the sealing surface and the backup ring can be narrowed, any shape of the narrowing means and any arrangement position are possible.

Further, it is also possible to use three or more of above embodiments in combination.

The connector device according to the present invention can be used for not only the connection of pipes in which pressurized and heated carbon dioxide gas flows in a cooling device, but also for sealing of other gas by suitably selecting the material of the seal member and the material of the backup ring.

As described above, according to the embodiments of the present invention, it is possible to provide a seal device using a general purpose seal member to simply and effectively seal connected members even in a state where gas can easily permeate through the seal member.

Further, according to the embodiments of the present invention, it is possible to provide a connector device using a general purpose seal member to simply and effectively seal pipes even in a state where gas flowing through the pipes can easily permeate through the seal member.

### INDUSTRIAL CAPABILITY

The connector device (seal device) of the present invention can be used for sealing various types of gases such as sealing in the refrigerant of a cooling device. Especially, the connector device of the present invention is suitable for sealing a gas with a small molecular weight and high pressure.

1-21. (canceled)

22. A CO₂ gas seal device comprising:
means (11, 13) for sealing the CO₂ gas; and
first and second connecting hollow members (7, 9),
the connection of said first and second connecting hollow members (7, 9) forming a connection part having a hollow part for passing the CO₂ gas through it between said first connecting hollow member and said second connecting hollow member and forms a groove (19G, 17G1, 17G2, 19G1) at a gas leakage part in the connection part,
said groove having a first part and a second part connected to the first part and having a sectional area smaller than that of the first part along the direction of leakage of said CO₂ gas, the second part has a tapered surface inclined so that its thickness becomes smaller along the direction of leakage of said CO₂ gas,
said gas sealing means having an O-ring (11) made of rubber arranged at the first part of said groove and one backup ring (13) made of 46Nylon arranged at the second part of said groove,
said backup ring having an inclined surface contacting the tapered surface of the second part of said groove, being enlarged in a diametrical direction at the second part of said groove by said CO₂ gas, the deformation of said O-ring (11), and a pressing action by the movement, and moves over the second part of said groove,
an angle of said inclined surface of said backup ring (13) being larger than the angle of the tapered surface of the second part of said groove, the inclined surface of the first gas seal member is crushed at the time of the pressing action by said CO₂ gas to further narrow the clearance of said second part, and
a front end of the second part of said groove being provided with a clearance from which said backup ring can be projected.

23. The CO₂ gas seal device as set forth in claim 22, wherein said O-ring arranged at the first part of said groove and the backup ring arranged at the second part of said groove are deformed due to a pressure difference along a direction of gas leakage of said CO₂ gas.

24. The connector device as set forth in claim 22, wherein:
said CO₂ gas is heated, and
said O-ring and said backup ring (11, 13) are heated by the temperature of said heated CO₂ gas and further expand and deform inside said groove.

25. The CO₂ gas seal device as set forth in claim 22, wherein:
said first connecting hollow part (7) has:
a first main body (70) and
a housing (17) formed integrally with the first main body (70) and having a hollow part (73),
said second connecting hollow part (9) has
a second main body (90) and
a shaft (19) formed integrally with the second main body (90), having a hollow part (93), and having a shaft (19) having an outside diameter enabling insertion into the hollow part (73) of said housing (17),
said shaft (19) is inserted with a predetermined clearance with an inner wall of the hollow part (73) of said housing (17) so that the hollow part (93) of said shaft (19) faces the hollow part (72) of said housing (17),
a groove (19G) is formed positioned between the outer circumference of said shaft (19) and the inner wall of the hollow part (73) of said housing (17) and having a first part (19B) into which said CO₂ gas is introduced on the outer circumference of said shaft (19) or the inner wall of the hollow part (73) of said housing (17) along a direction of flow of said CO₂ gas and a second part (19T) which continues from the first part, has a smaller cross section than the cross section of said first part, and from which said pressurized gas is discharged,
said O-ring (11) is arranged at the first part of said groove contacting the outer circumference of said shaft (19) and the inner wall of the hollow part (73) of said housing (17), and
said backup ring (13) is arranged at the second part of said groove.

26. The CO₂ gas seal device as set forth in claim 22, wherein:
said first connecting hollow part (7) has a first main body (70) and a housing (17) formed integrally with the first main body (70) and having a hollow part (73),
said second connecting hollow part (9) has a second main body (90) and a shaft (19) formed integrally with the second main body (90), having a hollow part (93), and having a shaft (19) having an outside diameter enabling insertion into the hollow part (73) of said housing (17),
said shaft (19) is inserted with a predetermined clearance with an inner wall of the hollow part (73) of said housing (17) so that the hollow part (93) of said shaft (19) faces the hollow part (72) of said housing (17),
said groove (19G) is defined positioned between the outer circumference of said shaft (19) and the inner wall of the hollow part (73) of said housing (17) and having a first part (19B) into which said CO₂ gas is introduced on the outer circumference of said shaft (19) or the inner wall of the hollow part (73) of said housing (17) along a direction of flow of said CO₂ gas and a second part (19T) which continues from the first part, has a smaller cross section than the cross section of said first part, and from which said pressurized gas is discharged,
said O-ring (11) is arranged at the first part of said groove contacting the outer circumference of said shaft (19) and the inner wall of the hollow part (73) of said housing (17), and
said backup ring (13) is arranged at the second part of said groove.

27. The CO₂ gas seal device as set forth in claim 26, wherein:
the second part of said groove is inclined so as to become shallower than a depth of said first part in a direction of discharge of said gas,
the angle of said inclined surface of said backup ring (13) contacting the second part of said groove is larger than the angle of the inclined surface of the second part of said groove, and the front end of the inclined surface of the first gas seal member is crushed at the time of the pressing action by said pressurized gas to further narrow the clearance of said second part.

28. The CO₂ gas seal device as set forth in claim 27, wherein:
a space between the hollow part of said housing (17) and the outer circumference of said shaft (19) forms the first part of the second groove,
an end surface on the front end of said housing (17) and a clearance facing the end surface of the main body of said second connecting hollow member form the second part of said second groove, and
a sheet-shaped second seal is fit at the second part of said second groove.

29. The CO₂ gas seal device as set forth in claim 27, wherein:
a second groove having a first part and a second part continuing from the first part and having a smaller cross section than that of said first part is annularly formed at the periphery of said shaft (19) along a direction of leakage of said CO₂ gas on either of the end surface of the front end of said housing (117) or the end surface of the main body of said second connecting hollow member, and
a sheet-shaped second seal member is fit at the second part of said second groove.
